(19) United States
(12) Patent Application Publication
(10) Pub. No.: US 2020/0311623 A1
(43) Pub. Date: Oct. 1, 2020

(54) PARKING MANAGEMENT APPARATUS, METHOD FOR CONTROLLING PARKING MANAGEMENT APPARATUS, AND STORAGE MEDIUM

(71) Applicant: HONDA MOTOR CO., LTD., Tokyo (JP)

(72) Inventors: Junpei Noguchi, Wako-shi (JP); Ryoma Taguchi, Tokyo (JP); Yuta Takada, Tokyo (JP); Chie Ito, Tokyo (JP)

(21) Appl. No.: 16/823,373

(22) Filed: Mar. 19, 2020

(30) Foreign Application Priority Data
Mar. 29, 2019 (JP) 2019-067299

(51) Int. Cl. G06Q 10/02; G06Q 50/30; B60W 60/00; G06Q 30/02; G07B 15/02

(52) U.S. Cl. CPC G06Q 10/02; G06Q 50/30; G07B 15/02; G06Q 30/0284; B60W 60/00253

(57) ABSTRACT

A parking management apparatus includes: an acquirer configured to acquire reservation information on the exit of a vehicle from a parking lot input by a user of the parking lot, and operation information of a means of transportation; an exit manager configured to store the reservation information on the exit of the vehicle from the parking lot acquired by the acquirer in a storage and to manage the reservation information; and a parking manager configured to transmit, to the vehicle, information for the vehicle requested to exit to autonomously travel from a parking position in the parking lot to a boarding area, wherein the exit manager changes the reservation information on the exit of the vehicle from the parking lot on the basis of operation information of the means of transportation used by the user from among the operation information of means of transportation acquired by the acquirer before the user arrives at the parking lot.

### CROSS-REFERENCE TO RELATED APPLICATION

Priority is claimed on Japanese Patent Application No. 2019-067299, filed Mar. 29, 2019, the content of which is incorporated herein by reference.

### BACKGROUND

### Field of the Invention

The present invention relates to a parking management apparatus, a method for controlling the parking management apparatus, and a storage medium.

### Description of Related Art

A conventional technology relating to parking lot reservation management for determining, when there is a request for a reservation from a parking lot user, whether the reservation can be received and executing the reservation when it is determined that the reservation can be received is disclosed (Japanese Unexamined Patent Application, First Publication No. H9-16898).

### SUMMARY

However, the conventional technology does not consider a situation in which a user uses other means of transportation such as an airplane or a train before he or she brings out a vehicle parked in a parking lot. Accordingly, when an operation state of a means of transportation has changed, it is necessary to change a parking reservation according to the changed operation state and such improvement of the convenience of parking reservation is desired.

An object of the present invention devised in view of the aforementioned circumstances is to provide a parking management apparatus, a method for controlling the parking management apparatus, and a storage medium which can improve the convenience of parking reservation.

A parking management apparatus, a method for controlling the parking management apparatus, and a storage medium according to the present invention employ the following configurations.

(1): A parking management apparatus according to one aspect of the present invention includes: an acquirer configured to acquire reservation information on the exit of a vehicle from a parking lot input by a user of the parking lot, and operation information of a means of transportation of which a use end point is associated with the parking lot and which is different from the vehicle; an exit manager configured to store the reservation information in a storage and to manage the reservation information; and a parking manager configured to transmit, to the vehicle, information for the vehicle requested to exit to autonomously travel from the parking lot to a boarding area, wherein the exit manager changes the reservation information on the exit of the vehicle from the parking lot on the basis of the operation information before the user arrives at the parking lot.

(2): In the above-described aspect of (1), the parking manager performs the exit of the vehicle from the parking lot on the basis of an arrival time at which the means of transportation used by the user arrives at the use end point, which is obtained with reference to the operation information.

(3): In the above-described aspect of (2), the exit manager transmits information for inquiring about whether to exit the vehicle from the parking lot to a terminal device carried by the user on the basis of the arrival time.

(4): In the above-described aspect of (1), the exit manager changes the reservation information on the exit of the vehicle from the parking lot on the basis of a delay situation of the operation of the means of transportation.

(5): In the above-described aspect of (4), when the operation of the means of transportation has been delayed, the exit imager transmits information for inquiring about whether to postpone an exit time to the terminal device carried by the user and postpones the exit time of the vehicle on the basis of a reply from the user.

(6): In the above-described aspect of (4), the exit manager transmits information for inquiring about a delay situation of the operation of the means of transportation to the terminal device carried by the user and changes the reservation information on the exit of the vehicle from the parking lot on the basis of a reply from the user.

(7): In the above-described aspect of (1), the parking management apparatus further includes a fee manager configured to manage a parking fee of the vehicle, wherein, when the reservation information on the exit of the vehicle has changed according to a delay situation of the operation of the means of transportation, the fee manager changes criteria for calculation of a parking fee of the vehicle to criteria for long-term parking.

(8): In the above-described aspect of (1), the parking lot includes a first parking area for short-term parking and a second parking area for long-term parking, and when a parking time of the vehicle parked in the first parking area exceeds a predetermined threshold value, the parking manager changes the parking position of the vehicle to the second parking area and transmits information for the vehicle to autonomously travel to the changed parking position to the vehicle.

(9): A method for controlling a parking management apparatus according to another aspect of the present invention, using a computer, includes: acquiring reservation information on the exit of a vehicle from a parking lot input by a user of the parking lot, and operation information of a means of transportation of which a use end point is associated with the parking lot and which is different from the vehicle; storing the reservation information in a storage and managing the reservation information; transmitting, to the vehicle, information for the vehicle requested to exit to autonomously travel from the parking lot to a boarding area; and changing the reservation information on the exit of the vehicle from the parking lot on the basis of the operation information before the user arrives at the parking lot.

(10): A storage medium according to another aspect of the present invention is a storage medium storing a program causing a computer to execute: processing of acquiring reservation information on the exit of a vehicle from a parking lot input by a user of the parking lot, and operation information of a means of transportation of which a use end point is associated with the parking lot and which is different from the vehicle; processing of storing the reservation information in a storage and managing the reservation information; processing of transmitting, to the vehicle, information for the vehicle requested to exit to autonomously travel from the parking lot to a boarding area; and processing of changing the reservation information on the exit of the vehicle from the parking lot on the basis of the operation information before the user arrives at the parking lot.

According to the aspects of (1) to (10), it is possible to improve the convenience of parking reservation.

### BRIEF DESCRIPTION OF THE DRAWINGS

FIG. 1 is a configuration diagram of a vehicle system.

FIG. 2 is a diagram showing a functional configuration of a first controller and second controller.

FIG. 3 is a diagram schematically showing a situation in which a self-driving parking event is performed.

FIG. 4 is a diagram showing an example of a configuration of a parking management apparatus.

FIG. 5 is a diagram showing an example of a parking space state table.

FIG. 6 is a diagram showing an example of a parking reservation table.

FIG. 7 is a diagram showing an example of a parking fee table.

FIG. 8 is a diagram showing an example of an image that a user is notified of.

FIG. 9 is a diagram showing an example of an image that a user is notified of.

FIG. 10 is a diagram showing an example of an image that a user is notified of.

FIG. 11 is a diagram for describing a parking fee calculation method.

FIG. 12 is a flowchart showing a flow of a series of processes of a parking management apparatus according to an embodiment.

FIG. 13 is a flowchart showing a flow of a series of processes of the parking management apparatus according to an embodiment.

FIG. 14 is a flowchart showing a flow of a series of processes of the parking management apparatus according to an embodiment.

FIG. 15 is a flowchart showing a flow of a series of processes of the parking management apparatus according to an embodiment.

FIG. 16 is a diagram showing an example of a hardware configuration of an automated driving control device according to an embodiment.

### DESCRIPTION OF EMBODIMENTS

Hereinafter, an embodiment of a parking management apparatus, a method for controlling the parking management apparatus, and a storage medium of the present invention will be described with reference to the drawings. As an example, an embodiment in which a target of parking management according to a parking management apparatus is an automated driving vehicle will be described below. Automated driving is to perform driving control by automatically controlling one or both of steering and acceleration/deceleration of a vehicle, for example. Driving control of an automated driving vehicle may be executed by manual operation of a user.

### [Overall Configuration]

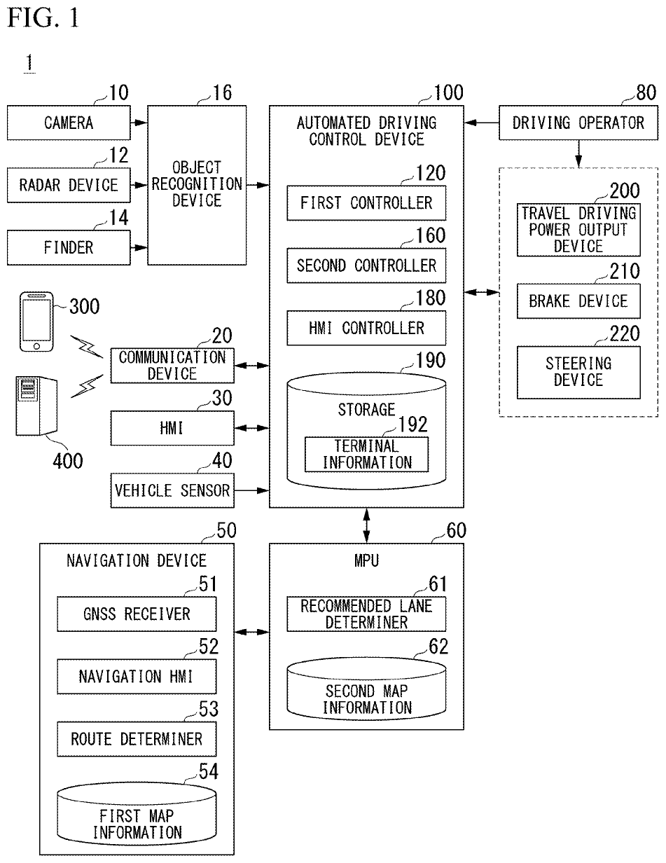

FIG. 1 is a configuration diagram of a vehicle system 1. For example, a vehicle equipped with the vehicle system 1 is a two-wheeled, three-wheeled, four-wheeled vehicle or the like and a driving source thereof includes an internal combustion engine such as a diesel engine, a gasoline engine or a hydrogen engine, a motor or a combination thereof. The motor operates using power generated by a generator connected to the internal combustion engine or power discharged from a battery (storage battery) such as secondary battery or a fuel battery.

For example, the vehicle system 1 may include a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. These devices and apparatuses are connected through a multiplex communication line such as a controller area network (CAN) communication line, and a serial communication line, a wireless communication network, and the like. The configuration shown in FIG. 1 is merely an example and a part of the configuration may be omitted or other configurations may be further added.

For example, the camera 10 may be a digital camera using a solid state imaging device such as a charge coupled device (CCD) or a complementary metal oxide semiconductor (CMOS). The camera 10 is attached to any portion of a vehicle in which the vehicle system 1 is mounted (hereinafter, a vehicle M). When a front view image is captured, the camera 10 is attached to the upper part of the front windshield, the rear side of a rear view mirror, or the like. For example, the camera 10 may periodically repeatedly capture images of the surroundings of the vehicle M. The camera 10 may be a stereo camera.

The radar device 12 radiates electric waves such as millimeter waves to the surroundings of the vehicle M and detects electric waves (reflected waves) reflected by an object to detect at least the position (distance and direction) of the object. The radar device 12 is attached to any portion of the vehicle M. The radar device 12 may detect the position and speed of an object according to a frequency modulated continuous wave (FM-CW) method.

The finder 14 is a light detection and ranging (LIDAR) device. The finder 14 radiates light to the surroundings of the vehicle M and measures scattering light. The finder 14 detects a distance to a target on the basis of a time from light emission to light reception. Radiated light may be pulsed laser light, for example. The finder 14 is attached to any portion of the vehicle M.

The object recognition device 16 performs a sensor fusion process on detection results of some or all of the camera 10, the radar device 12 and the finder 14 to recognize the position, type, speed and the like of an object. The object recognition device 16 outputs a recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

The communication device 20 communicates with, for example, a terminal device 300 used by a user U of the vehicle M, other vehicles around the vehicle M, a parking management apparatus 400, or various server devices using a cellular network, a Wi-Fi network, Bluetooth (registered trademark), dedicated short range communication (DSRC) and the like, for example. Although the terminal device 300 may be a portable terminal carried by the user U, such as a smartphone or a tablet terminal, for example, the terminal device 300 is not limited thereto and may be a management terminal, a server device or the like used by a manager or the like set in advance. The terminal device 300 will be described as a terminal carried by a user in the following.

The HMI 30 presents various types of information to a user of the vehicle M and receives an input operation from the user. The HMI 30 includes a display device, a speaker, a buzzer, a touch panel, switches, keys, and the like. For example, the display device may include a meter display provided at a portion of an instrument panel which faces a driver, a center display provided at the center of the instrument panel, a head up display (HUD), and the like. The HUD may be, for example, a device for causing a user to view an image overlaid on a landscape, and as an example, causes the user to view a virtual image by projecting light including an image to a front windshield or a combiner of the vehicle M.

The vehicle sensor 40 includes a vehicle speed sensor that detects the speed of the vehicle M, an acceleration sensor that detects an acceleration, a yaw rate sensor that detects an angular velocity around a vertical axis, a heading sensor that detects the direction of the vehicle M, etc. The vehicle sensor 40 may include a load sensor that detects a load applied to each seat in a vehicle cabin. Results detected by the vehicle sensor 40 are output to the automated driving control device 100.

The navigation device 50 may include a global navigation satellite system (GNSS) receiver 51, a navigation HMI 52 and a route determiner 53, for example. The navigation device 50 stores first map information 54 in a storage device such as a hard disk drive (HDD) or a flash memory. The GNSS receiver 51 identifies the position of the vehicle M on the basis of signals received from a GNSS satellite. The position of the vehicle M may be identified or complemented by an inertial navigation system (INS) using the output of the vehicle sensor 40. The navigation HMI 52 includes a display device, a speaker, a touch panel, keys, etc. A part or all of the navigation HMI 52 and the aforementioned HMI 30 may be made to be common. The route determiner 53 determines a route (hereinafter, a route on a map) to a destination input by a user using the navigation HMI 52 from the position of the vehicle M identified by the GNSS receiver 51 (or any input position) with reference to the first map information 54, for example. The first map information 54 is information representing road shapes according to links indicating roads and nodes connected by links, for example. The first map information 54 may include curvatures and point of interest (POI) information of roads, and the like. A route on a map is output to the MPU 60. The navigation device 50 may perform route guide using the navigation HMI 52 on the basis of roads on a map. For example, the navigation device 50 may be realized by functions of the terminal device 300 of the user U. The navigation device 50 may transmit a current position and a destination to a navigation server through the communication device 20 and acquire the same route as a route on a map from the navigation server. The navigation device 50 outputs a determined route on a map to the MPU 60.

The MPU 60 includes a recommended lane determiner 61, for example, and stores second map information 62 in a storage device such as an HDD or a flash memory. The recommended lane determiner 61 divides a route on a map provided from the navigation device 50 into a plurality of blocks (divides the route into intervals of 100 m in a vehicle traveling direction, for example) and determines a recommended lane for each block with reference to the second map information 62. The recommended lane determiner 61 performs determination in such a manner that on which lane from the left the vehicle will travel is determined. When a route on a map includes a branch point, the recommended lane determiner 61 determines recommended lanes such that the vehicle M can travel on a reasonable route for traveling to a branch destination.

The second map information 62 is map information with higher-accuracy than the first map information 54. For example, the second map information 62 may include information on the centers of lanes or information on the boundaries of lanes. The second map information 62 may include road information, traffic regulations information, address information (addresses and zip codes), facility information, parking lot information, telephone number information, etc. The parking lot information may be the position and shape of a parking space in which a vehicle will be parked, the number of vehicles that can be parked, whether manned traveling is performed, whether unmanned traveling is performed, and the like, for example. The second map information 62 may be updated at any time through communication between the communication device 20 and other devices.

The driving operator 80 includes an accelerator pedal, a brake pedal, a shift lever, a steering wheel, a modified steering wheel, a joystick and other operators, for example. A sensor that detects an operation amount or presence or absence of an operation is attached to the driving operator 80 and a detection result thereof is output to the automated driving control device 100 or some or all of the travel driving power output device 200, the brake device 210 and the steering device 220.

The automated driving control device 100 may include a first controller 120, a second controller 160, an HMI controller 180, and a storage 190, for example. Each of the first controller 120, the second controller 160 and the HMI controller 180 is realized by a hardware processor such as a central processing unit (CPU) executing a program (software), for example. Some or all of these components may be realized by hardware (circuit device; including circuitry) such as a large scale integration (LSI) circuit, an application specific integrated circuit (ASIC), a field-programmable gate array (FPGA) and a graphics processing unit (GPU) or realized by software and hardware in cooperation. Programs may be stored in advance in a storage device (storage device including a non-transitory storage medium) of the automated driving control device 100, such as an HDD or a flash memory, or stored in a detachable storage medium such as a DVD or a CD-ROM and installed in the HDD or the flash memory of the automated driving control device 100 by setting the storage medium (non-transitory storage medium) in a drive device.

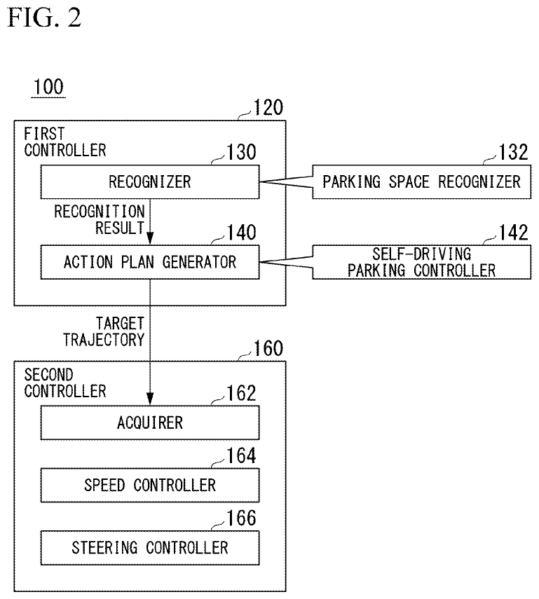

FIG. 2 is a diagram showing a functional configuration of the first controller 120 and the second controller 160. The first controller 120 may include a recognizer 130 and an action plan generator 140, for example. The first controller 120 may realize a function using artificial intelligence (AI) and a function using a model provided in advance in parallel, for example. For example, a function of “recognizing an intersection” may be realized by performing recognition of an intersection using deep learning or the like and recognition based on conditions provided in advance (which include a signal which can be pattern-matched, road markings and the like) in parallel and assigning scores to both the recognitions to integrally evaluate the recognitions. Accordingly, reliability of automated driving is secured.

The recognizer 130 recognizes states such as the position, speed and acceleration of an object around the vehicle M on the basis of information input from the camera 10, the radar device 12 and the finder 14 through the object recognition device 16. For example, the position of an object may be recognized as a position on absolute coordinates having a representative point (the center of gravity, the center of the drive shaft or the like) of the vehicle M as the origin and used for control. The position of an object may be represented as a representative point of the object, such as the center of gravity or a corner, or may be represented as a representative region. “States” of an object may include the acceleration and jerk of the object or an “action state” (e.g., whether lane change is being performed or is intended to be performed).

The recognizer 130 recognizes a lane (traveling lane) in which the vehicle M is traveling, for example. For example, the recognizer 130 may recognize a traveling lane by comparing a lane marking pattern (e.g., arrangement of solid lines and dashed lines) obtained from the second map information 62 with a lane marking pattern around the vehicle M recognized from an image captured by the camera 10. The recognizer 130 may recognize a traveling lane by recognizing lane boundaries (road boundaries) including lane markings, road shoulders, curbs, medians, guardrails and the like as well as lane markings. In such recognition, the position of the vehicle M acquired from the navigation device 50 and a processing result of the INS may be additionally taken into account. The recognizer 130 recognizes temporary stop lines, obstacles, a red signal, tollgates, entrance gates of parking lots, and other road states.

The recognizer 130 recognizes a position and an attitude of the vehicle M with respect to a traveling lane when the traveling lane is recognized. For example, the recognizer 130 may recognize a distance between a reference point of the vehicle M and the center of the lane and an angle between a traveling direction of the vehicle M and a line connecting the center of the lane as a relative position and attitude of the vehicle M with respect to the traveling lane. Instead of this, the recognizer 130 may recognize the position of the reference point of the vehicle M or the like with respect to any side edge of the traveling lane (a lane marking or a road boundary) as a relative position of the vehicle M with respect to the traveling lane.

The recognizer 130 includes a parking space recognizer 132 that starts in a self-driving parking event which will described later. Functions of the parking space recognizer 132 will be described in detail later.

The action plan generator 140 generates a target trajectory through which the vehicle M will automatically travel (without depending on an operation of a driver) in the future such that the vehicle M travels in a recommended lane determined by the recommended lane determiner 61 in principle and can cope with a surrounding situation thereof. For example, a target trajectory may include a speed factor. For example, a target trajectory is represented as a sequential arrangement of points (trajectory points) at which the vehicle M will arrive. A trajectory point is a point at which the vehicle M will arrive for each predetermined traveling distance (e.g., approximately several meters) in a distance along a road, and a target speed and a target acceleration for each predetermined sampling time (e.g., every several tens of a second) are generated as a part of a target trajectory apart from trajectory points. A trajectory point may be a position at which the vehicle M will arrive at a sampling time for each predetermined sampling time. In this case, information on a target speed and a target acceleration are represented by a spacing between trajectory points.

The action plan generator 140 may set an automated driving event upon generation of a target trajectory. Automated driving events include a constant-speed traveling event, a constant-speed takeover event, a lane change event, a branch event, a merging event, a takeover event, a self-driving parking event of parking in a parking lot through automated traveling, such as valet parking, and the like. Automated traveling may be traveling according to automated driving, for example. Automated traveling may include unmanned traveling, for example. The action plan generator 140 generates a target trajectory in response to a started event. The action plan generator 140 includes a self-driving parking controller 142 that starts when the self-driving parking event is executed. Functions of the self-driving parking controller 142 will be described in detail later.

The second controller 160 controls the travel driving power output device 200, the brake device 210 and the steering device 220 such that the vehicle M passes through a target trajectory generated by action plan generator 140 on scheduled time. For example, the second controller 160 may include an acquirer 162, a speed controller 164 and a steering controller 166. The acquirer 162 acquires information on a target trajectory (trajectory points) generated by the action plan generator 140 and stores the information on a memory (not shown). The speed controller 164 controls the travel driving power output device 200 or the brake device 210 on the basis of a speed factor belonging to the target trajectory stored in the memory. The steering controller 166 controls the steering device 220 in response to a degree of bending of the target trajectory stored in the memory. Processing of the speed controller 164 and the steering controller 166 is realized by feedforward control and feedback control in combination, for example. As an example, the steering controller 166 performs feedforward control according to a curvature of a road ahead of the vehicle M and feedback control based on a distance from a target trajectory in combination.

Referring back to FIG. 1, the HMI controller 180 notifies a user of predetermined information to using the HMI 30. For example, the predetermined information may be information related to traveling of the vehicle M, such as information about states of the vehicle M and information about driving control. For example, the information about states of the vehicle M may include the speed, engine speed and a shift position of the vehicle M, and the like. The information about driving control may include presence or absence of execution of automated driving, information about a degree of driving assistance according to automated driving, and the like, for example. The predetermined information may include information that is not related to traveling of the vehicle M, such as television programs and content (e.g., movies) stored in a storage medium such as a DVD. The HMI controller 180 may output information received through the HMI 30 to the communication device 20, the navigation device 50, the first controller 120, and the like.

The HMI controller 180 may perform communication with the terminal device 300 through the communication device 20 and output information acquired from the terminal device 300 to the HMI 30. The HMI controller 180 may perform control for causing a display device of the HMI 30 to display a registration screen through which the terminal device 300 which will communicate with the vehicle M is registered and storing information (e.g., address information) about the terminal device registered through the registration screen in terminal information 192. When the vehicle M is caused to enter or exit a parking area through automated driving according to a self-driving parking event (when self-driving parking is performed), for example, the terminal device 300 which will communicate with the vehicle M may be a terminal device which instructs the vehicle M to enter or exit. Registration of the aforementioned terminal device 300 may be executed at a predetermined timing before a user rides a vehicle or self-driving parking starts, for example. Registration of the aforementioned terminal device 300 may be performed using an application program (a vehicle cooperation application which will be described later) installed in the terminal device 300.

The storage 190 may be realized by, for example, an HDD, a flash memory, an EEPROM, a read only memory (ROM), a random access memory (RAM), or the like. For example, the terminal information 192 and other pieces of information may be stored in the storage 190.

The travel driving power output device 200 includes an engine and an engine electronic control unit (ECU) which controls the engine when the vehicle M is a car having an internal combustion engine as a driving source thereof, for example. The engine ECU adjusts a throttle opening, a shift stage, and the like of the engine according to information input from the second controller 160 or information input from the driving operator 80 and outputs a travel driving power (torque) for traveling of the vehicle M.

The brake device 210 may include a brake caliper, a cylinder which transfers a hydraulic pressure to the brake caliper, an electric motor which generates a hydraulic pressure in the cylinder, and a brake ECU, for example. The brake ECU controls the electric motor according to information input from the second controller 160 and information input from the driving operator 80 such that a brake torque according to the braking operation is output to each vehicle wheel. The brake device 210 may include a mechanism for transferring a hydraulic pressure generated by an operation of a brake pedal included in the driving operator 80 to the cylinder through a master cylinder as a backup. The brake device 210 is not limited to the above-described configuration and may be an electronically controlled hydraulic brake device which controls an actuator according to information input from the second controller 160 and transfers a hydraulic pressure of a master cylinder to a cylinder.

The steering device 220 may include a steering ECU and an electric motor, for example. For example, the electric motor may change the direction of the steering wheel by applying a force to a rack-and-pinion mechanism. The steering ECU drives the electric motor according to information input from the second controller 160 or information input from the driving operator 80 to change the direction of the steering wheel.

Next, driving control of the vehicle M in an embodiment will be described in detail. A situation in which self-driving parking is performed through unmanned traveling for valet parking in a visit place facility will be described below as an example of a situation in which driving control of the vehicle M is executed.

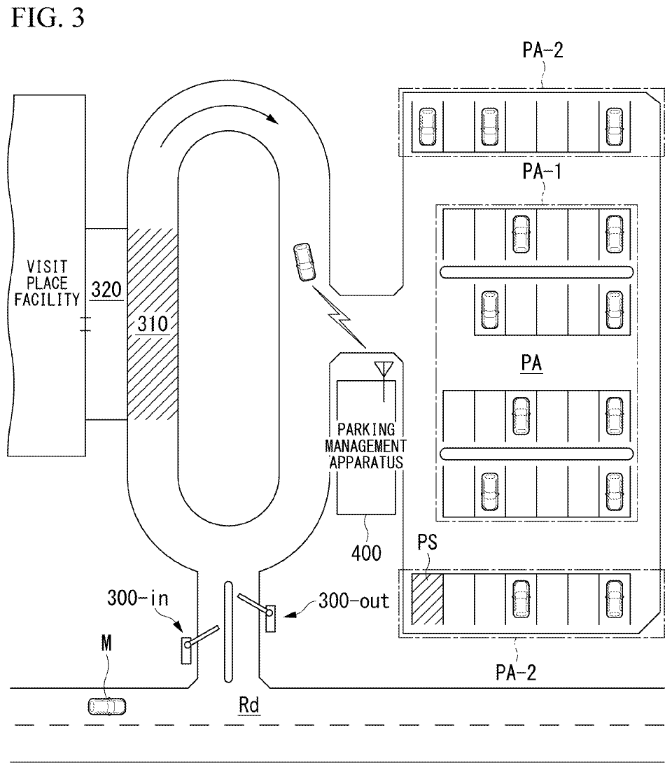

FIG. 3 is a diagram schematically showing a situation in which a self-driving parking event in an embodiment is executed. In the example of FIG. 3, a parking area (e.g., a valet parking area) PA of a visit place facility is illustrated. The parking area PA may be an area in which a vehicle can be caused to travel or parked according to automated driving, for example. The parking area PA may be assumed to be an area in which traveling can be performed according to unmanned traveling and manned traveling and passing of a user of a vehicle is permitted, for example. Manned traveling may include, for example, traveling according to manual driving and traveling according to automated driving in a state in which a user is in the vehicle. The parking area PA may include a first parking area PA-1 for short-term parking and a second parking area PA-2 for long-term parking, for example.

For example, gates 300-in and 300-out on a route from a road Rd to the visit place facility, a boarding area 310, and a waiting area 320 may be provided in the parking area PA. In the example of FIG. 3, it is assumed that a parking management apparatus 400 which manages parking states of the parking area PA and transmits a vacancy state and the like to vehicles is provided.

Here, processing during entry and exit of the vehicle M according to a self-driving parking event will be described.

### [Self-Driving Parking Event—During Entry]

The self-driving parking controller 142 may cause the vehicle M to be parked in a parking space of the parking area PA on the basis of information acquired from the parking management apparatus 400 through the communication device 20, for example. In this case, the vehicle M passes through the gate 300-in and moves to the boarding area 310 according to manual driving or automated driving. The boarding area 310 faces the waiting area 320 connected to the visit place facility. An eave for blocking the rain and snow may be provided in the waiting area 320.

The vehicle M performs automated driving after the user U alights from the vehicle M in the boarding area 310 and starts a self-driving parking event for moving to a parking space PS in the parking area PA. A self-driving parking event starting trigger may be an operation performed by the user U (e.g., an entry instruction from the terminal device 300) or wireless reception of a predetermined signal from the parking management apparatus 400, for example. The self-driving parking controller 142 controls the communication device 20 to transmit a parking request to the parking management apparatus 400 when the self-driving parking event is started. Then, the vehicle M moves from the boarding area 310 to the parking area PA according to guidance of the parking management apparatus 400 or while performing sensing by itself.

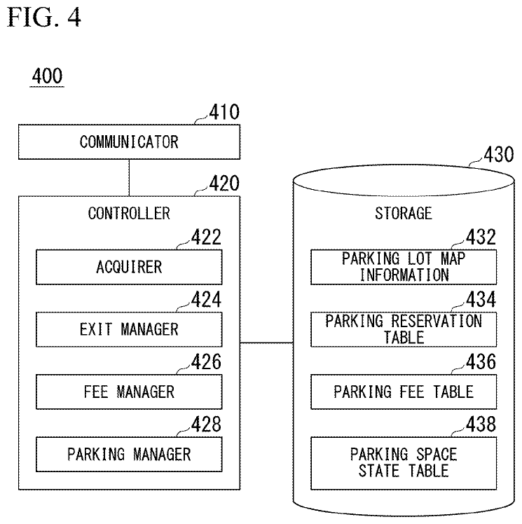

FIG. 4 is a diagram showing an example of a configuration of the parking management apparatus 400. For example, the parking management apparatus 400 may include a communicator 410, a controller 420, and a storage 430. For example, the controller 420 may include an acquirer 422, an exit manager 424, a fee manager 426, and a parking manager 428. The storage 430 stores information such as parking lot map information 432, a parking reservation table 434, a parking fee table 436, and a parking space state table 438.

The communicator 410 wirelessly communicates with the vehicle M and other vehicles. The controller 420 guides a vehicle to a parking space PS on the basis of information acquired through the communicator 410 and information stored in the storage 430. The parking lot map information 432 is information geometrically representing the structure of the parking area PA. The parking lot map information 432 includes coordinates of each parking space PS.

The acquirer 422 acquires reservation information on the exit of a vehicle from the parking lot input by a parking lot user and operation information on a means of transportation. The means of transportation is a means of transportation of which a use end point is associated with the parking lot and which is different from the vehicle M. For example, the means of transportation is used before the user takes the vehicle out of the parking lot. For example, the acquirer 422 acquires reservation information on the exit of the vehicle input by the parking lot user to the terminal device 300 through the communicator 410. For example, the acquirer 422 may acquire operation information on means of transportation managed by various server devices through the communicator 410.

The exit manager 424 registers reservation information on the exit of the vehicle from the parking lot acquired by the acquirer 422 in the parking reservation table 434 of the storage 430. The exit manager 424 changes reservation information on the exit of the vehicle from the parking lot on the basis of operation information of the means of transportation acquired by the acquirer 422. In the present embodiment, a means of transportation is a means of transportation used before a user takes a vehicle out of the parking lot and may include a train, an airplane, a ship, or the like, for example. When the operation of the means of transportation has been delayed, the exit manager 424 postpones the time at which the vehicle exits the parking lot according to a degree of the delay.

The fee manager 426 calculates a parking fee based on a parking time of a vehicle in the parking lot with reference to the parking fee table 436. The fee manager 426 sets criteria for calculation of a parking fee of the vehicle M to criteria for short-term parking when the operation of the means of transportation has not been delayed. On the other hand, the fee manager 426 sets the criteria for calculation of a parking fee of the vehicle M to criteria for long-term parking when the operation of the means of transportation has been delayed. Then, the fee manager 426 transmits information about the parking fee to the terminal device 300 carried by the user U through the communicator 410.

The parking manager 428 manages a parking position of a vehicle in the parking lot with reference to the parking space state table 438. When the parking time of the vehicle parked in the first parking area exceeds a predetermined threshold value, the parking manager 428 changes the parking position of the vehicle to the second parking area. Then, the parking manager 428 transmits information for autonomous travel of the vehicle to the changed parking position to the vehicle M through the communicator 410.

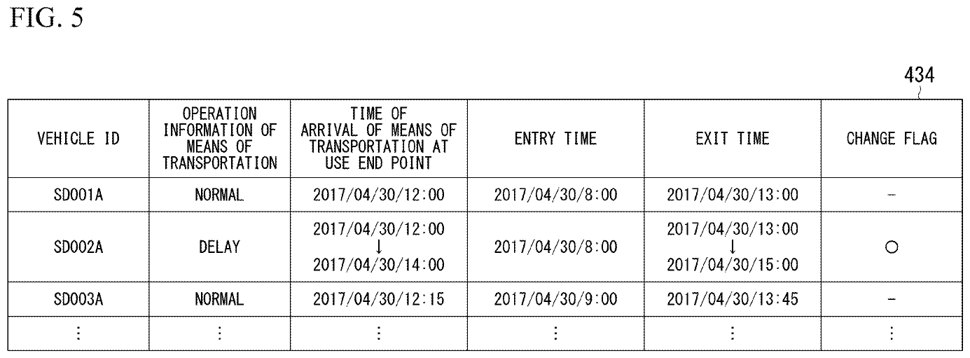

As shown in FIG. 5, in the parking reservation table 434, a vehicle ID that is identification information on a vehicle is associated with operation information on a means of transportation related to the vehicle, an assumed time of arrival of the means of transportation at a use end point, a time at which the vehicle enters the parking lot, a time at which the vehicle exits the parking lot, and a change flag indicating the presence or absence of change in the time of the exit of the vehicle from the parking lot, for example. A use end point is a point associated with a parking lot used by a user and may include a station, an airport, a harbor, and the like, for example. Operation information on a means of transportation may be information about delay of the operation of the means of transportation, for example, and includes information about the presence or absence of delay of the operation of the means of transportation or a degree of delay. A time of arrival of a means of transportation at a use end point is calculated with reference to the operation information of the means of transportation used by a user while the user uses the means of transportation. That is, when the operation of the means of transportation has been delayed, the time of arrival of the means of transportation at the use end point is also postponed according to a degree of the delay. An entry time is recorded in the storage 430 in association with a vehicle ID at the time when the vehicle enters the parking lot. An exit time is recorded in the storage 430 in association with the vehicle ID at the time when a parking reservation of the vehicle is received. The exit time is changed on the basis of the operation information on the means of transportation. That is, when the operation of the means of transportation has been delayed, the exit time is also postponed according to a degree of the delay. Then, the exit manager 424 sets a change flag associated with the vehicle ID to ON when the exit time has changed on the basis of the operation information of the means of transportation.

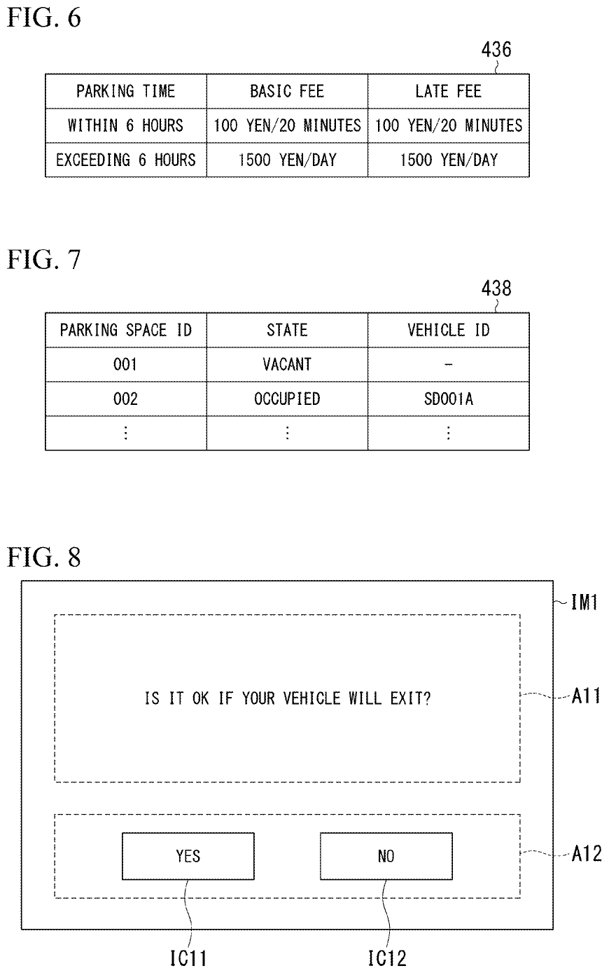

As shown in FIG. 6, in the parking fee table 436, a vehicle parking time is associated with a parking fee addition table, for example. A parking fee may include a basic fee and a late fee, for example, and the basic fee and the late fee are added on the basis of a vehicle parking time.

As shown in FIG. 7, in the parking space state table 438, a parking space ID that is identification information of a parking space PS is associated with a state representing whether the parking space PS is vacant or occupied (has a vehicle parked therein) and a vehicle ID that is identification information of a vehicle parked therein when the parking space PS is occupied, for example.

When the communicator 410 receives a parking request from a vehicle, the parking manager 428 extracts a parking space (vacant space) PS in a vacant state with reference to the parking space state table 438, acquires the position of the extracted parking space PS from the parking lot map information 432 and transmits a suitable route to the acquired position of the parking space PS to the vehicle using the communicator 410. The parking manager 428 instructs a specific vehicle to stop, slow down or the like as necessary such that vehicles do not simultaneously advance to the same position on the basis of a positional relation of a plurality of vehicles.

In the vehicle which has received the route (which is assumed to be the vehicle M hereinafter), the self-driving parking controller 142 generates a target trajectory based on the route. When the vehicle M approaches a parking space PS that is a target, the parking space recognizer 132 recognizes a parking line that defines the parking space PS, recognizes the detailed position of the parking space PS and provides the detailed position to the self-driving parking controller 142. The self-driving parking controller 142 receives the detailed position, corrects the target trajectory and causes the vehicle M to be parked in the parking space PS.

The present invention is not limited to the above description and the self-driving parking controller 142 may discover a parking space in a vacant state by itself on the basis of a detection result of the camera 10, the radar device 12, the finder 14 or the object recognition device 16 without depending on communication and cause the vehicle M to be parked in the discovered parking space.

### [Self-Driving Parking Event—During Exit]

The self-driving parking controller 142 and the communication device 20 maintain operating states even when the vehicle M is parked. For example, when the communication device 20 has received a pickup request (call request) that is an example of an exit instruction from the parking management apparatus 400, the self-driving parking controller 142 starts the system of the vehicle M and causes the vehicle M to move to the boarding area 310. In this case, the parking management apparatus 400 transmits a suitable route from a parking space PS to the boarding area 310 to the vehicle M using the communicator 410. The suitable route from the parking space PS to the boarding area 310 is an example of information for the vehicle M requested to exit to autonomously travel from the parking position in the parking lot to the boarding area. The information for autonomous travel of the vehicle M may be information about control parameters used to control steering or acceleration/deceleration of the vehicle M or information about a command for instructing the vehicle M to exit the parking lot, for example. The self-driving parking controller 142 controls the communication device 20 to transmit a departure request to the parking management apparatus 400. The parking management apparatus 400 instructs a specific vehicle to stop, slow down or the like as necessary such that vehicles do not simultaneously advance to the same position on the basis of a positional relation of a plurality of vehicles as in vehicle entry. When the vehicle M moves to the boarding area 310 and the user U boards the vehicle M, the self-driving parking controller 142 stops to operate, and then manual driving or automated driving by a separate functional part is started.

When a self-driving parking event is executed, the HMI controller 180 may notify the user U who has alighted from the vehicle of execution of the self-driving parking event by generating information about a vehicle situation according to self-driving parking (parking control according to automated travel) and transmitting the generated information to the terminal device 300. The information about the vehicle situation according to self-driving parking may include a travel state (during entry or during exit) of the vehicle M, a traveling position, an estimated time of arrival at the boarding area 310, a scheduled travel route from the parking position to the boarding area 310, an internal temperature of the vehicle cabin, and the like, for example.

[Notification control of HMI controller]

Next, specific examples of notification control of the HMI controller 180 will be described. A notification control pattern for each occasion will be described below.

### <First Notification Control Pattern>

The first notification control pattern is a notification control pattern when a reservation situation of the exit of the vehicle M from the parking lot is consistent with a current situation. In the first notification control pattern, first, the exit manager 424 of the parking management apparatus 400 determines whether the reservation situation of the exit of the vehicle M from the parking lot is consistent with the current situation with reference to the parking reservation table 434 stored in the storage 430. Then, the exit manager 424 determines that execution of a self-driving parking event by the terminal device 300 is likely to be instructed when it is determined that the reservation situation of the exit of the vehicle M from the parking lot is consistent with the current situation. In this case, the self-driving parking controller 142 executes processing of accessing the terminal device 300, for example, on the basis of address information included in the terminal information 192 stored in the storage 190 and determines that the terminal device 300 can execute the self-driving parking event when it can access the terminal device 300. Then, when it is determined that the exit manager 424 instructs the self-driving parking event to be executed, the HMI controller 180 performs a notification to the user U using one or both of the HMI 30 and the terminal device 300.

FIG. 8 is a diagram showing an example of an image IM1 used to notify a user. The image shown in FIG. 8 is an example of an image displayed on the terminal device 300. The same applies to examples of other images which will be described later. The image IM1 may include a notification information display area A11 and a graphical user interface (GUI) switch display area A12, for example. In the example of FIG. 8, the message “Should we bring your vehicle out?” corresponding to an inquiry about whether the vehicle M will exit the parking lot is displayed in the notification information display area A11.

Icons by which an instruction from a user is received may be displayed in the GUI switch display area A12, for example. For example, the icons may include a first icon IC11 indicating the letters “YES” and a second icon IC12 indicating the letters “NO.” When the user U selects the first icon IC11 or the second icon IC12, the terminal device 300 transmits a signal representing the type of the selected icon IC11 or IC12 to the parking management apparatus 400. When a signal representing selection of the first icon IC11 is received from the terminal device 300, the parking manager 428 of the parking management apparatus 400 transmits a pickup request to the self-driving parking controller 142 of the vehicle M using the communicator 410. On the other hand, when a signal representing selection of the second icon IC12 is received from the terminal device 300, the parking manager 428 of the parking management apparatus 400 ends display of the image IM1 through the terminal device 300 instead of transmitting the pickup request to the self-driving parking controller 142 of the vehicle M.

### <Second Notification Control Pattern>

The second notification control pattern is a notification control pattern when the operation of a means of transportation used by a user has been delayed. In the second notification control pattern, first, the acquirer 422 of the parking management apparatus 400 acquires operation information on means of transportation managed by various servers through the communicator 410. The acquirer 422 of the parking management apparatus 400 determines whether the operation of a means of transportation has been delayed on the basis of the operation information on the means of transportation used by the user from among the acquired operation information on means of transportation. When it is determined that the operation of the means of transportation has been delayed, the acquirer 422 outputs a change request for the time of the exit of the vehicle M from the parking lot to the exit manager 424. When the change request for the time of the exit is acquired from the acquirer 422, the exit manager 424 notifies the user U of the change request using one or both of the HMI 30 and the terminal device 300.

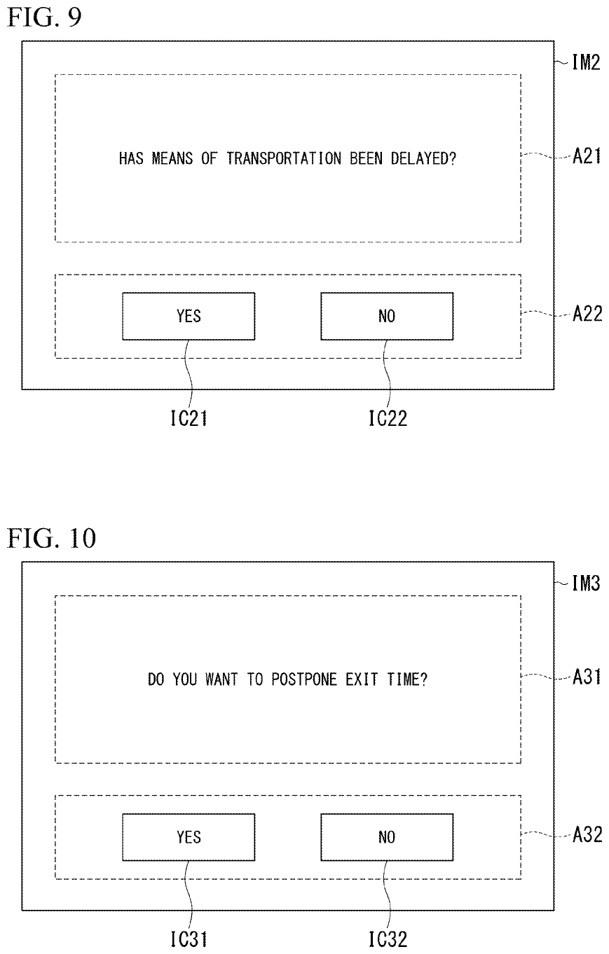

FIG. 9 is a diagram showing an example of an image IM2 used to notify the user U. For example, the image IM2 may include a notification information display area A21 and a GUI switch display area A22. In the example of FIG. 9, the message “Has the means of transportation been delayed?” corresponding to an inquiry about a delay situation of the operation of the means of transportation is displayed in the notification information display area A21.

Icons by which an instruction from a user U is received may be displayed in the GUI switch display area A22, for example. For example, the icons may include a first icon IC21 indicating the letters “YES” and a second icon IC22 indicating the letters “NO.” When the user U selects the first icon IC21 or the second icon IC22, the terminal device 300 transmits a signal representing the type of the selected icon IC21 or IC22 to the parking management apparatus 400. When a signal representing selection of the first icon IC21 is received from the terminal device 300, the exit manager 424 of the parking management apparatus 400 performs a notification to the user U using one or both of the HMI 30 and the terminal device 300. On the other hand, when a signal representing selection of the second icon IC22 is received from the terminal device 300, the exit manager 424 of the parking management apparatus 400 ends display of the image IM2 through the terminal device 300 instead of performing a notification to the user U.

FIG. 10 is a diagram showing an example of an image IM3 used to notify the user U. For example, the image IM3 may include a notification information display area A31 and a GUI switch display area A32. In the example of FIG. 10, the message “Do you want to postpone the exit time?” corresponding to an inquiry about whether to postpone the exit time is displayed in the notification information display area A31.

Icons by which an instruction from a user U is received may be displayed in the GUI switch display area A32, for example. For example, the icons may include a first icon IC31 indicating the letters “YES” and a second icon IC32 indicating the letters “NO.” When the user U selects the first icon IC31 or the second icon IC32, the terminal device 300 transmits a signal representing the type of the selected icon IC31 or IC32 to the parking management apparatus 400. When a signal representing selection of the first icon IC31 is received from the terminal device 300, the exit manager 424 of the parking management apparatus 400 changes information about the exit time of the vehicle M registered in the parking reservation table 434 of the storage 430. On the other hand, when a signal representing selection of the second icon IC32 is received from the terminal device 300, the exit manager 424 of the parking management apparatus 400 ends display of the image IM3 through the terminal device 300 instead of changing the information about the exit time of the vehicle M registered in the parking reservation table 434 of the storage 430.

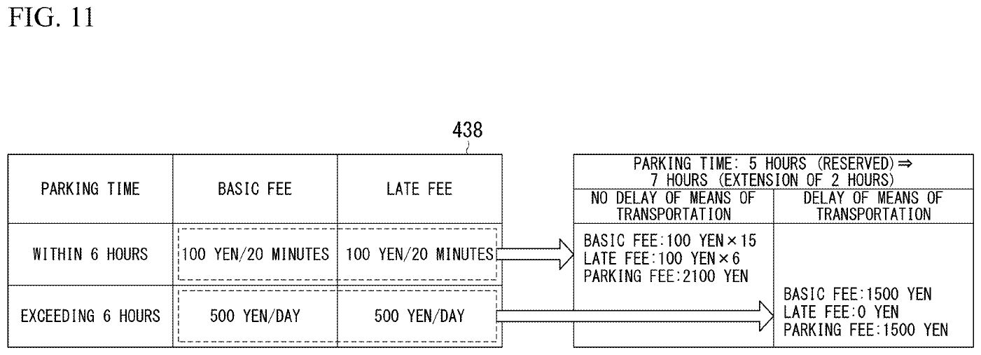

FIG. 11 is a diagram for describing a parking fee calculation method. In the example shown in FIG. 11, it is assumed that a reservation time has actually increased by two hours although five hours were initially reserved for the parking time of the vehicle M. In this case, the fee manager 426 calculates a parking fee on the basis of criteria for short-term parking when the means of transportation has not been delayed and calculates a parking fee on the basis of criteria for long-term parking when the means of transportation has been delayed with reference to the parking fee table 436. In this example, addition tables for a basic fee and a late fee on the basis of parking time are different in the parking fee table 436 according to whether the parking time is within six hours or exceeds six hours. In addition, in this example, the fee manager 426 calculates the parking fee of the vehicle M using the addition table when the parking time is within six hours when the means of transportation has not been delayed because five hours were initially reserved for the parking time. On the other hand, when the means of transportation has been delayed, although five hours were initially reserved for the parking time, the fee manager 426 performs processing on the assumption that a parking time exceeding six hours has been initially reserved because extension of the parking time is caused by delay of the means of transportation. Then, the fee manager 426 calculates the parking fee of the vehicle M using an addition table when the parking time exceeds six hours.

### [Processing Flow]

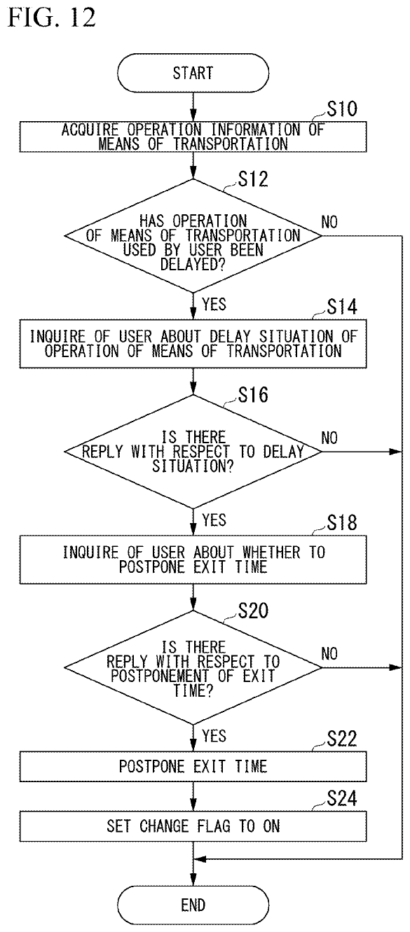

FIG. 12 is a flowchart showing an example of a processing flow when the parking management apparatus 400 according to an embodiment postpones the time of the exit of the vehicle M from the parking lot according to a delay situation of the operation of a means of transportation. Processing of this flowchart may be repeatedly performed at a predetermined interval or predetermined timing, for example.

First, the acquirer 422 acquires operation information of means of transportation from various server devices through the communicator 410 (step S10). Thereafter, the acquirer 422 determines whether operation information of a means of transportation used by a user from among the operation information on means of transportation acquired from the various server devices includes delay information (step S12). Then, the exit manager 424 ends processing of this flowchart when the acquirer 422 determines that the operation information of the means of transportation does not include the delay information. On the other hand, when the acquirer 422 determines that the operation information of the means of transportation includes the delay information, the exit manager 424 inquires of the user U about a delay situation of the operation of the means of transportation by transmitting a request signal to the terminal device 300 carried by the user U (step S14). The exit manager 424 determines whether there is a reply from the terminal device 300 with respect to the delay situation of the means of transportation (step S16). Then, the exit manager 424 inquires of the user U about whether to postpone an exit time by transmitting a request signal to the terminal device 300 when it is determined that there is a reply from the terminal device 300 with respect to the delay situation of the means of transportation (step S18). The exit manager 424 determines whether there is a reply with respect to postponement of the exit time (step S20). Then, the exit manager 424 postpones the exit time of the vehicle M registered in the parking reservation table 434 of the storage 430 according to a degree of delay of the operation of the means of transportation when it is determined that there is a reply from the terminal device 300 with respect to postponement of the exit time (step S22). The exit manager 424 sets a change flag registered in the parking reservation table 434 of the storage 430 to ON (step S24). Accordingly, processing of this flowchart ends.

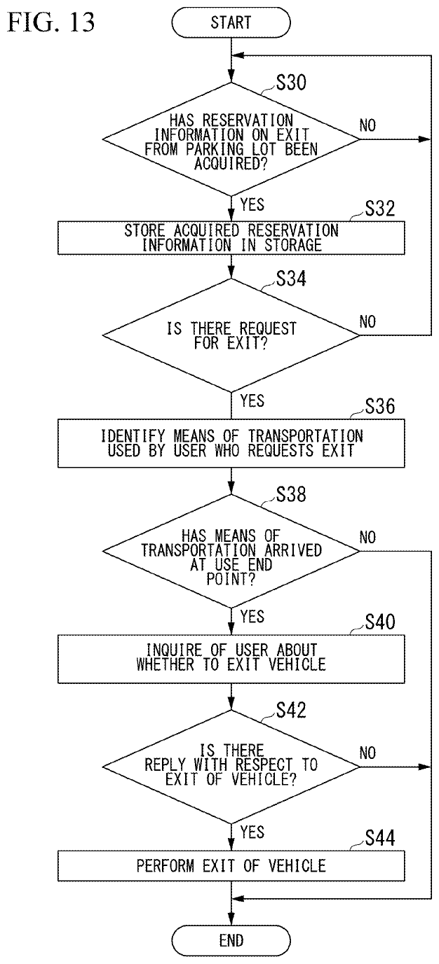

FIG. 13 is a flowchart showing an example of a processing flow when the parking management apparatus 400 according to an embodiment causes the vehicle M to exit from the parking lot. Processing of this flowchart may be repeatedly performed at a predetermined interval or predetermined timing, for example.

First, the acquirer 422 determines whether reservation information with respect to exit from the parking lot has been acquired from the terminal device 300 carried by a user (step S30). When the acquirer 422 determines that the reservation information with respect to exit has been acquired, the exit manager 424 registers the acquired reservation information in the parking reservation table 434 of the storage 430 (step S32). Thereafter, the exit manager 424 determines whether there is a request for the exit of the vehicle M from the parking lot (step S34). In this case, the exit manager 424 determines whether a reservation situation with respect to the exit of the vehicle M from the parking lot is consistent with a current situation. When the exit manager 424 determines that there is a request for the exit of the vehicle M from the parking lot, the parking manager 428 identifies a means of transportation used by the user U who has requested the exit of the vehicle M with reference to the parking reservation table 434 stored in the storage 430 (step S36). Then, the parking manager 428 acquires operation information of the means of transportation used by the user U from various server devices. The parking manager 428 determines whether the means of transportation used by the user has arrived at a use end point on the basis of the operation information of the means of transportation acquired from the various server devices (step S38). Then, the parking manager 428 inquires of the user U about whether to cause the vehicle M to exit from the parking lot by transmitting a request signal to the terminal device 300 carried by the user U when it is determined that the means of transportation has arrived at the use end point (step S40). The parking manager 428 determines whether there is a reply from the terminal device 300 with respect to the exit of the vehicle M (step S42). Then, the parking manager 428 performs the exit of the vehicle M from the parking lot by transmitting a suitable route from a parking space PS to the boarding area 310 to the vehicle M using the communicator 410 when it is determined that there is a reply from the terminal device 300 with respect to the exit of the vehicle M (step S44). Accordingly, processing of this flowchart ends.

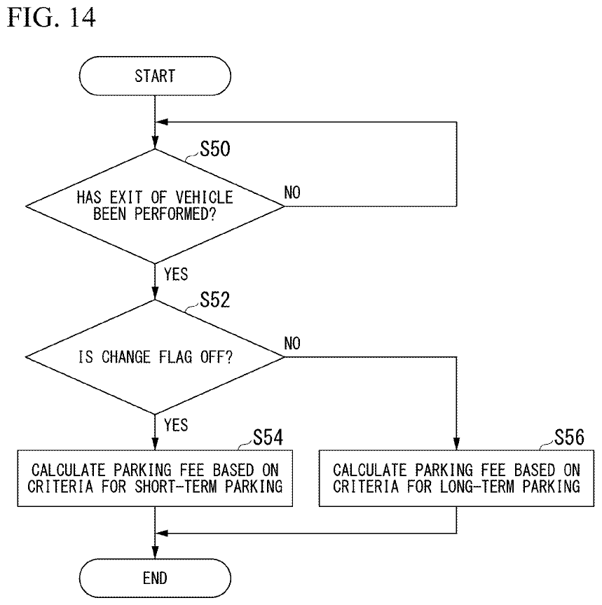

FIG. 14 is a flowchart showing an example of a processing flow when the parking management apparatus 400 according to an embodiment calculates a parking fee of the vehicle M. Processing of this flowchart may be repeatedly performed at a predetermined interval or predetermined timing, for example.

First, the fee manager 426 determines whether the parking manager 428 has performed the exit of the vehicle M from the parking lot (step S50). When it is determined that the parking manager 428 has performed the exit of the vehicle M from the parking lot, the fee manager 426 determines whether a change flag corresponding to the vehicle M which has exited has been set to OFF with reference to the parking reservation table 434 (step S52). Then, the fee manager 426 calculates a parking fee of the vehicle M based on the criteria for short-term parking with reference to the parking fee table 436 when it is determined that the change flag has been set to OFF (step S54). On the other hand, the fee manager 426 calculates a parking fee of the vehicle M based on the criteria for long-term parking with reference to the parking fee table 436 when it is determined that the change flag has been set to ON (step S56).

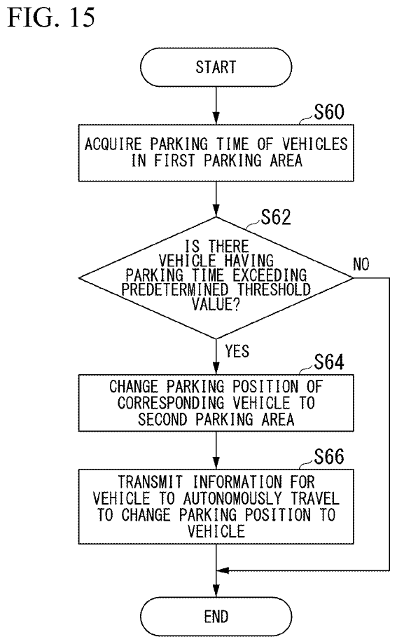

FIG. 15 is a flowchart showing an example of a processing flow when the parking management apparatus 400 according to an embodiment changes a parking position of the vehicle M in the parking lot. Processing of this flowchart may be repeatedly performed at a predetermined interval or predetermined timing, for example.

First, the parking manager 428 acquires a parking time of the vehicle M in the first parking area with reference to the parking space state table 438 (step S60). The parking manager 428 determines whether vehicles parked in the first parking area include a vehicle having a parking time exceeding a predetermined threshold value (step S62). When it is determined that the vehicles include a vehicle having a parking time exceeding the predetermined threshold value, the parking manager 428 changes the parking position of the corresponding vehicle to the second parking area (step S64). Then, the parking manager 428 transmits information for the vehicle M to autonomously travel to the changed parking position to the vehicle M through the communicator 410 (step S66). Accordingly, processing of this flowchart ends.

### [Hardware Configuration]

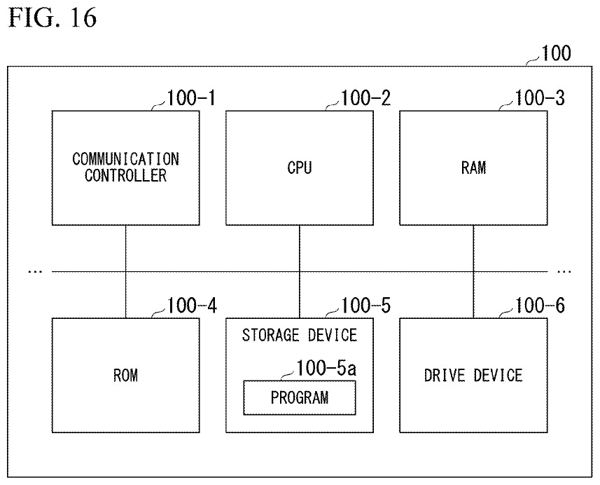

FIG. 16 is a diagram showing an example of a hardware configuration of the automated driving control device 100 of an embodiment. As shown, the automated driving control device 100 is configured in such a manner that a communication controller 100-1, a CPU 100-2, a RAM 100-3 used as a working memory, a ROM 100-4 storing a boot program and the like, a storage device 100-5 such as a flash memory or an HDD, a drive device 100-6, and the like are connected through an internal bus or a dedicated communication line. The communication controller 100-1 performs communication with components other than the automated driving control device 100. The drive device 100-6 includes a portable storage medium (e.g., a computer-readable non-transitory storage medium) such as an optical disc mounted therein. The storage device 100-5 stores a program 100-5a executed by the CPU 100-2. This program is developed in the RAM 100-3 through a direct memory access (DMA) controller (not shown) or the like and executed by the CPU 100-2. The program 100-5a referred to by the CPU 100-2 may be stored in the portable storage medium mounted in the drive device 100-6 or downloaded from other devices through a network. Accordingly, some or all of the functions of the automated driving control device 100 are realized.

According to the parking management apparatus 400 according to the above-described embodiment, it is possible to improve the convenience of parking reservation. For example, when the operation of a means of transportation has been delayed, a user needs to postpone the time of the exit of a vehicle M from the parking lot according to a degree of delay of the operation of the means of transportation by operating the terminal device 300. On the contrary, the parking management apparatus 400 according to the embodiment automatically postpones the time of the exit of the vehicle M from the parking lot according to a degree of delay when an operating situation of the means of transportation has been delayed. Accordingly, it is possible to improve the convenience of parking reservation.

According to the parking management apparatus 400, it is possible to improve the comfortability of parking reservation. For example, when an operating situation of a means of transportation has been delayed, there are cases in which a parking time of a vehicle M increases from an initially scheduled time and a late fee is added based on the increased time. On the contrary, the parking management apparatus 400 according to the embodiment changes a parking fee calculation method with reference to the parking fee table 436 such that the late fee based on the increased time is reduced when the parking time of the vehicle M increases due to delay in the operation of the means of transportation. Accordingly, it is possible to improve the comfortability of parking reservation.

According to the parking management apparatus 400, it is possible to perform the exit of a vehicle M from a parking lot with high efficiency. For example, when a vehicle M having a relatively long parking time and a vehicle M having a relatively short parking time are parked at neighboring parking positions in a parking lot, there are cases in which the exit of the vehicles M from the parking lot cannot be performed with high efficiency. On the contrary, the parking management apparatus 400 according to the embodiment sets a first parking area for short-term parking and a second parking area for long-term parking in the parking lot, and when the parking time of the vehicle M parked in the first parking area exceeds a predetermined threshold value, changes the parking position of the vehicle M to the second parking area. Accordingly, the parking position of the vehicle M in the parking lot is managed based on the parking time and thus the exit of the vehicle M from the parking lot can be performed with high efficiency.

While forms for embodying the present invention have been described using embodiments, the present invention is not limited to these embodiments and various modifications and substitutions can be made without departing from the spirit or scope of the present invention.

What is claimed is:

1. A parking management apparatus comprising:
an acquirer configured to acquire reservation information on the exit of a vehicle from a parking lot input by a user of the parking lot, and operation information of a means of transportation of which a use end point is associated with the parking lot and which is different from the vehicle;
an exit manager configured to store the reservation information in a storage and to manage the reservation information; and
a parking manager configured to transmit, to the vehicle, information for the vehicle requested to exit to autonomously travel from the parking lot to a boarding area,
wherein the exit manager changes the reservation information on the exit of the vehicle from the parking lot on the basis of the operation information before the user arrives at the parking lot.

2. The parking management apparatus according to claim 1, wherein the parking manager performs the exit of the vehicle from the parking lot on the basis of an arrival time at which the means of transportation used by the user arrives at the use end point, which is obtained with reference to the operation information.

3. The parking management apparatus according to claim 2, wherein the exit manager transmits information for inquiring about whether to exit the vehicle from the parking lot to a terminal device of the user on the basis of the arrival time.

4. The parking management apparatus according to claim 1, wherein the exit manager changes the reservation information on the exit of the vehicle from the parking lot on the basis of a delay situation of the operation of the means of transportation.

5. The parking management apparatus according to claim 4, wherein, when the operation of the means of transportation has been delayed, the exit imager transmits information for inquiring about whether to postpone an exit time to the terminal device of the user and postpones the exit time of the vehicle on the basis of a reply from the user.

6. The parking management apparatus according to claim 4, wherein the exit manager transmits information for inquiring about a delay situation of the operation of the means of transportation to the terminal device of the user and changes the reservation information on the exit of the vehicle from the parking lot on the basis of a reply from the user.

7. The parking management apparatus according to claim 1, further comprising a fee manager configured to manage a parking fee of the vehicle,
wherein, when the reservation information on the exit of the vehicle has changed according to a delay situation of the operation of the means of transportation, the fee manager changes criteria for calculation of a parking fee of the vehicle to criteria for long-term parking.

8. The parking management apparatus according to claim 1, wherein the parking lot includes a first parking area for short-term parking and a second parking area for long-term parking, and
wherein, when a parking time of the vehicle parked in the first parking area exceeds a predetermined threshold value, the parking manager changes a parking position of the vehicle to the second parking area and transmits information for the vehicle to autonomously travel to the changed parking position to the vehicle.

9. A method for controlling a parking management apparatus, comprising, using a computer:
acquiring reservation information on the exit of a vehicle from a parking lot input by a user of the parking lot, and operation information of a means of transportation of which a use end point is associated with the parking lot and which is different from the vehicle;
storing the reservation information in a storage and managing the reservation information;
transmitting, to the vehicle, information for the vehicle requested to exit to autonomously travel from the parking lot to a boarding area; and
changing the reservation information on the exit of the vehicle from the parking lot on the basis of the operation information before the user arrives at the parking lot.

10. A computer-readable non-transitory storage medium storing a program causing a computer to execute:
processing of acquiring reservation information on the exit of a vehicle from a parking lot input by a user of the parking lot, and operation information of a means of transportation of which a use end point is associated with the parking lot and which is different from the vehicle;
processing of storing the reservation information in a storage and managing the reservation information;
processing of transmitting, to the vehicle, information for the vehicle requested to exit to autonomously travel from the parking lot to a boarding area; and
processing of changing the reservation information on the exit of the vehicle from the parking lot on the basis of the operation information before the user arrives at the parking lot.
